(19) United States
(12) Patent Application Publication
(10) Pub. No.: US 2007/0148600 A1
(43) Pub. Date: Jun. 28, 2007

(54) ACTIVE ENERGY RAY-CURABLE RESIN COMPOSITION AND METHOD FOR FORMING RESIST PATTERN

(76) Inventors: Takeya HASEGAWA, Hiratsuka-shi, Kanagawa (JP); Daisuke KOJIMA, Hiratsuka-shi, Kanagawa (JP); Genji IMAI, Hiratsuka-shi, Kanagawa (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/616,705

(22) Filed: Dec. 27, 2006

(30) Foreign Application Priority Data
Dec. 27, 2005 (JP) 2005-376240

(51) Int. Cl. G03C 5/00

(52) U.S. Cl. 430/311

(57) ABSTRACT

Disclosed are an active energy ray-curable resin composition, wherein when the active energy ray-curable resin composition is coated onto a substrate and made into a resist film with a predetermined thickness, a ratio (Y/X) of a quantity of a transmitted active energy ray (Y) after transmission through the resist film to a quantity of an initial active energy ray (X) on the surface of the resist film is 10% or less in a spectral sensitivity wavelength range of the resist film; and a method for forming a resist pattern by using this composition.

### BACKGROUND OF THE INVENTION

1. Field of the Invention

The present invention relates to an active energy ray-curable resin composition and a method for forming a resist pattern by using this resin composition.

2. Description of the Related Art

In prior methods for forming a resist pattern, light reflection from the base substrate surface of a resist film is known to cause halation and thereby inhibit the shape of the resist pattern. To solve this problem, there are disclosed methods, for example, a method wherein a dye is formulated in a resist composition (see Japanese Patent Laid-Open Nos. 47-38037 and 11-160860), a method wherein an anti-light-reflection layer is formed on a base substrate surface (see Japanese Patent Laid-Open No. 5-343314), and a method using a negative chemically amplified photosensitive composition comprising an alkali-soluble resin, a compound which generates an acid by active ray irradiation, a crosslinking agent which crosslinks with the generated acid, and a light absorbent having a particular structure (see Japanese Patent Laid-Open No. 2000-258904).

However, the method wherein a dye is formulated in a resist composition presents the problems of deteriorated resolution of the resist pattern and insufficient anti-halation effect on a thin resist film. Alternatively, the method wherein an anti-light-reflection layer is formed presents the significant problem of increased burdens of etching. Moreover, the method using a negative chemically amplified photosensitive composition requires heat treatment and therefore presents the problems of high cost and cumbersome process control.

An object of the present invention is to provide a method for forming a resist pattern, which reduces light reflection from a base substrate surface in the formation of a resist pattern, particularly a resist pattern of a thin film, and to provide a resin composition used in the method.

### SUMMARY OF THE INVENTION

The present invention provides an active energy ray-curable resin composition, wherein when the active energy ray-curable resin composition is coated onto a substrate and made into a resist film with a predetermined thickness, a ratio (Y/X) of a quantity of a transmitted active energy ray (Y) after transmission through the resist film to a quantity of an initial active energy ray (X) on the surface of the resist film is 10% or less in a spectral sensitivity wavelength range of the resist film.

The present invention further provides a method for forming a resist pattern, comprising the steps of:
(1) applying the active energy ray-curable resin composition of claim 1 onto a substrate to thereby form a resist film with a predetermined thickness;
(2) irradiating the resist film directly or via a negative mask with an active energy ray to thereby cure the resist film into a desired pattern; and
(3) developing the resist film cured in the desired pattern to thereby form a resist pattern onto the substrate.

The present invention has a remarkable advantage that a desired resist pattern can be formed on a resist film, particularly even a thin resist film, by preventing halation caused by light reflection.

Especially, the above advantage is increased by using an active energy ray as the irradiating light and an unsaturated group containing resin as the resist resin composition, furthermore, blending a light absorbent into the resist resin composition wherein the light absorbent can absorb a specific waive length in the active energy ray.

### DETAILED DESCRIPTION OF THE PREFERRED EMBODIMENTS

When an active energy ray-curable resin composition of the present invention is coated onto a substrate and made into a resist film with a predetermined thickness, a ratio (Y/X) of a quantity of a transmitted active energy ray (Y) after transmission through the resist film to a quantity of an initial active energy ray (X) on the surface of the resist film is 10% or less, preferably 5% or less, in a spectral sensitivity wavelength range of the resist film. When the ratio (Y/X) stands at such a low value, the unirradiated part of the resist film is not cured, permitting for the formation of a delicate pattern. The quantity of active energy ray (X) on the surface of the resist film is a quantity of active energy ray measured on the irradiation-side surface of the resist film. The quantity of transmitted active energy ray (Y) after transmission through the resist film is a quantity of active energy ray after transmission through the resist film measured on the irradiation-opposite side surface of the resist film under the same irradiation condition (e.g., a light source, a distance from the light source, and a irradiation time) as the condition for measuring the quantity of active energy ray (X).

The ratio (Y/X) of a quantity of a transmitted active energy ray (Y) to a quantity of an initial active energy ray (X) can be determined in a manner described below.

First, the active energy ray-curable resin composition is coated onto one side of a transparent substrate (e.g., a glass substrate) prepared for measurement, and thereby made into a resist film with a predetermined thickness. In this context, the “predetermined thickness” means a thickness of resist film when it is actually mounted. Consequently, the predetermined thickness is a thickness of resist film when it is actually used for forming a resist pattern, and the thickness is not limited to be a fixed value. However, the quantities are generally measured at a thickness of 10 μm or 5 μm. Especially, it is preferable that the ratio (Y/X) is 10% or less even if the thickness is 5 μm. Then the resist film is subsequently irradiated with an active energy ray under actual irradiation conditions. A quantity of a transmitted active energy ray (Y′) after transmission through the resist film is measured. The quantity of transmitted active energy ray (Y′) after transmission through the resist film is a quantity of active energy ray after transmission through the transparent substrate coated with the resist film measured on the irradiation-opposite side surface of the transparent substrate coated with the resist film. The transparent substrate used in this measurement is used as a blank to measure in advance a quantity of a transmitted active energy ray (Z) after transmission through the transparent substrate. The quantity of transmitted active energy ray (Z) after transmission through the transparent substrate is a quantity of active energy ray after transmission through the transparent substrate measured on the irradiation-opposite side surface of the transparent substrate under the same irradiation condition (e.g., a light source, a distance from the light source, and a irradiation time) as the condition for measuring the quantity of active energy ray (Y′). The unit of the quantity of the ray is J/m².

A value of the ratio (Y/X) can be calculated with the thus-obtained quantities of the energy rays according to the formula [Y′/Z] and thereby determined.

Preferably, the active energy ray-curable resin composition of the present invention comprises a base resin (A) comprising an unsaturated group and an ionic group, a radical photoinitiator (B), and a light absorbent (C).

<Base Resin (A)>

The base resin (A) may be any light-curable resin that has an unsaturated group capable of polymerizing by a radical generated from the radical photoinitiator (B) caused by active energy ray irradiation and has an ionic group (anionic or cationic group) imparting thereto the function by which a coating of the unexposed part can be dissolved and thereby removed with an alkaline or acidic liquid developer. The type thereof is not particularly limited.

The weight-average molecular weight of the base resin (A) is preferably 2,000 to 100,000, more preferably 3,000 to 80,000. The lower limit of each of these ranges is significant from the viewpoint of clarifying a boundary surface between the unirradiated part and the irradiated part. The upper limit is significant from the viewpoint of the solubility of the uncured part (unirradiated part) to a liquid developer. These actions can form a delicate pattern more favorably.

The glass transition temperature of the base resin (A) is preferably −20 to 100° C., more preferably −10 to 90° C. The lower limit of each of these ranges is significant from the viewpoint of clarifying a boundary surface between the unirradiated part and the irradiated part. The upper limit is significant from the viewpoint of the solubility of the uncured part to a liquid developer. These actions can form a delicate pattern more favorably.

The unsaturated group concentration of the base resin (A) is preferably 0.1 to 10 unsaturated groups, more preferably 0.5 to 8 unsaturated groups, on average per molecule. The lower limit of each of these ranges is significant from the viewpoint of curability. The upper limit is significant from the viewpoint of strippability.

Examples of the unsaturated group contained in the base resin (A) include acryloyl, methacryloyl, vinyl, styryl, and allyl groups.

The ionic group contained in the base resin (A) is an anionic or cationic group. The representative examples of the anionic group include a carboxyl group. The content of the anionic group such as a carboxyl group is preferably approximately 10 to 300 mg KOH/g, more preferably approximately 20 to 200 mg KOH/g, in terms of the resin acid value. The lower limit of each of these ranges is significant from the viewpoint of the solubility of the uncured part to a liquid developer. The upper limit is significant from the viewpoint of preventing the coating of the cured part from being removed. The representative examples of the cationic group include an amino group. The content of the amino group is preferably approximately 10 to 300, more preferably approximately 20 to 200, in terms of the resin amine number. The lower limit of each of these ranges is significant from the viewpoint of the solubility of the uncured part to a liquid developer. The upper limit is significant from the viewpoint of preventing the coating of the cured part from being removed.

Examples of the base resin comprising the anionic group include a polycarboxylic acid resin comprising an unsaturated group and a carboxyl group introduced therein by reaction with, for example, a monomer such as glycidyl(meth)acrylate. Examples of the base resin comprising the cationic group include a resin produced by addition-reacting a resin containing a hydroxyl group and a tertiary amino group with a reaction product between an unsaturated compound containing a hydroxyl group and a diisocyanate compound.

For example, a light-curable resin described in Japanese Patent Laid-Open No. 3-223759 can also be used as the base resin comprising the anionic or cationic group.

Furthermore, for example, an acid-denatured epoxy(meth)acrylate resin produced by reacting a reaction product between an epoxy resin (e.g., phenol novolac, cresol novolac, trisphenolmethane, bisphenol A, bisphenol F, hydrogenated bisphenol A, and hydrogenated bisphenol F epoxy resins) and (meth)acrylic acid with polybasic carboxylic acid or an anhydride thereof (e.g., maleic acid, phthalic acid, tetrahydrophthalic acid, hexahydrophthalic acid, HET acid (chlorendic acid), and anhydrides of these acids) can also be used as the base resin comprising the anionic group.

<Radical Photoinitiator (B)>

Examples of the radical photoinitiator (B) include: aromatic carbonyl compounds such as benzophenone, benzoin methyl ether, benzoin isopropyl ether, benzylxanthone, thioxanthone, and anthraquinone; acetophenones such as acetophenone, propiophenone, α-hydroxyisobutylphenone, α,α′-dichloro-4-phenoxyacetophenone, 1-hydroxy-1-cyclohexylacetophenone, and diacetyl-acetophenone; organic peroxides such as benzoyl peroxide, t-butyl peroxy-2-ethylhexanoate, t-butyl hydroperoxide, di-t-butyl diperoxyisophthalate, and 3,3′,4,4′-tetra(t-butylperoxycarbonyl)benzophenone; diphenylhalonium salts such as diphenyliodonium bromide and diphenyliodonium chloride; organo-halides such as carbon tetrabromide, chloroform, and iodoform; heterocyclic and polycyclic compounds such as 3-phenyl-5-isoxazolone and 2,4,6-tris(tri-chloromethyl)-1,3,5-triazinebenzanthrone; azo compounds such as 2,2′-azobis(2,4-dimethylvaleronitrile), 2,2-azobisisobutyronitrile, 1,1′-azobis(cyclo-hexane-1-carbonitrile), and 2,2′-azobis(2-methylbutyronitrile); iron-allene complexes (see European Patent No. 152377); titanocene compounds (see Japanese Patent Laid-Open No. 63-221110); bisimidazole compounds; N-arylglycidyl compounds; acridine compounds; combinations of aromatic ketone with aromatic amine; and peroxyketal (see Japanese Patent Laid-Open No. 6-321895). Among them, acetophenones are preferable because of their high activities for crosslinking or polymerization.

Examples of trade names of commercially available products that can be used as the radical photoinitiator (B) include Irgacure 651 (manufactured by Ciba Specialty Chemicals, acetophenone-based radical polymerization photoinitiator), Irgacure 184 (manufactured by Ciba Specialty Chemicals, acetophenone-based radical polymerization photoinitiator), Irgacure 1850 (manufactured by Ciba Specialty Chemicals, acetophenone-based radical polymerization photoinitiator), Irgacure 907 (manufactured by Ciba Specialty Chemicals, aminoalkylphenone-based radical polymerization photoinitiator), Irgacure 369 (manufactured by Ciba Specialty Chemicals, aminoalkylphenone-based radical polymerization photoinitiator), Irgacure 379 (manufactured by Ciba Specialty Chemicals, aminoalkylphenone-based radical polymerization photoinitiator), Lucirin TPO (manufactured by BASF Corp., 2,4,6-trimethyl-benzoyidiphenylphosphine oxide), Kayacure DETXS (manufactured by Nippon Kayaku Co., Ltd.), and CGI-784 (manufactured by Ciba Specialty Chemicals, titanium complex compound).

These radical photoinitiators can be used alone or in combination of two or more of them. Among them, Irgacure 907 and Irgacure 369 are particularly preferable.

The proportion of the radical photoinitiator (B) formulated is preferably 0.1 to 25 parts by weight, more preferably 0.2 to 10 parts by weight, with respect to 100 parts by weight of the base resin (A). The lower limit of each of these ranges is significant from the viewpoint of curability. The upper limit is significant from the viewpoint of reducing cost while maintaining sufficient curability.

<Light Absorbent (C)>

Examples of the light absorbent (C) include a light absorbent that absorbs a wavelength of 400 nm or more, such as a monoazo compound, a yellow compound, and a compound represented by the following general formula (I):

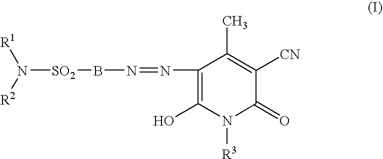

wherein R¹ represents a hydrogen atom, alkyl group, aryl group, cycloalkyl group, or aralkyl group, R² represents an alkyl group having 5 or more carbon atoms, R³ represents a hydrogen atom or alkyl group having 1 to 6 carbon atoms, and B represents a benzene ring which may have a nitro group, cyano group, alkyl group, alkoxy group, chlorine, bromine, phenyl group, or phenoxy group.

Trade names of commercially available products that can be used as the light absorbent (C) include: ORASOL YELLOW 4GN (manufactured by Ciba Specialty Chemicals); OIL COLORS YELLOW 3G SOLVENT YELLOW 16, OIL COLORS YELLOW GGS SOLVENT YELLOW 56, OIL COLORS YELLOW 105, and OIL COLORS YELLOW 129 SOLVENT YELLOW 29 (all manufactured by Orient Chemical Industries, Ltd.); and NEPTUN YELLOW 075 (manufactured by BASF Corp). Among them, ORASOL YELLOW 4GN, OIL COLORS YELLOW GGS SOLVENT YELLOW 56, and NEPTUN YELLOW 075 are preferable from the viewpoint of solubility to the resin composition.

The proportion of the light absorbent (C) formulated may be set so that the ratio (Y/X) does not exceed 10%. The proportion of the light absorbent (C) formulated that falls within this range of the ratio (Y/X) differs depending on a resist film thickness. In general, the proportion is preferably 0.01 to 10 parts by weight, more preferably 0.1 to 5 parts by weight, particularly preferably 1 to 5 parts by weight, with respect to 100 parts by weight of the base resin (A).

The resin composition of the present invention can further comprise a polyfunctional unsaturated compound formulated therein, in addition to each component described above. Examples of the polyfunctional unsaturated compound include (meth)acrylic acid ester of a polyhydric alcohol. Specific examples of the polyfunctional unsaturated compound include: di(meth)acrylate compounds such as ethylene glycol di(meth)acrylate, diethylene glycol di-(meth)acrylate, triethylene glycol di(meth)acrylate, tetraethylene glycol di-(meth)acrylate, 1,3-butylene glycol di(meth)acrylate, 1,4-butanediol diacrylate, 1,9-nonanediol di(meth)acrylate, glycerin di(meth)acrylate, trimethylolpropane di(meth)acrylate, pentaerythritol di(meth)acrylate, neopentyl glycol diacrylate, 1,6-hexanediol diacrylate, bisphenol A-ethylene oxide-denatured diacrylate, polyester di(meth)acrylate, and urethane di(meth)acrylate; tri(meth)acrylate compounds such as glycerin tri(meth)acrylate, trimethylolpropane tri(meth)-acrylate, trimethylolpropane-propylene oxide-denatured tri(meth)acrylate, trimethylolpropane-ethylene oxide-denatured tri(meth)acrylate, and penta-erythritol tri(meth)acrylate; tetra(meth)acrylate compounds such as penta-erythritol tetra(meth)acrylate; and dipentaerythritol penta(meth)acrylate and dipentaerythritol hexa(meth)acrylate. These polyfunctional unsaturated compounds can be used alone or in combination of two or more of them.

The proportion of the polyfunctional unsaturated compound formulated is preferably 1 to 100 parts by weight, more preferably 5 to 50 parts by weight, with respect to 100 parts by weight of the base resin (A).

The resin composition of the present invention can further comprise a saturated resin formulated therein, in addition to each component described above. The saturated resin is employed, for example, for the purpose of suppressing the solubility of the base resin (A). Specifically, it is used as a suppressing agent against solubility to a strong alkaline solution, for example, for adjusting the solubility of the resist film to an alkaline liquid developer and the removability of the light-curable film. Examples of the saturated resin include polyester resins, alkyd resins, (math)acrylic resins, vinyl resins, epoxy resins, phenol resins, natural resins, synthetic rubbers, silicon resins, fluoro-carbon resins, and polyurethane resins. These saturated resins can be used alone or in combination of two or more of them.

Furthermore, a photosensitizer can also be used. Specific examples thereof include thioxanthene, xanthene, ketone, thiopyrylium salt, base styryl, merocyanine, 3-substituted coumarin, coumarin, 3,4-substituted coumarin, cyanin, acridine, thiazine, phenothiazine, anthracene, coronene, benzanth-racene, perylene, ketocoumarin, fumarine, borate dyes. These photosensi-tizers can be used alone or in combination of two or more of them. Examples of the borate dye include those described in Japanese Patent Laid-Open Nos. 5-241338, 7-5685, and 7-225474.

The resin composition of the present invention can be used as an organic solvent-based composition in which the composition comprising the components (A) to (C) and other components as required is dissolved or dispersed in an organic solvent (e.g., ketones, esters, ethers, cellosolves, aromatic hydrocarbons, alcohols, and halogenated hydrocarbons). Alternatively, the resin composition of the present invention can also be used as an aqueous composition in which the composition is dispersed in water by use of the ionic group in the resin component.

In the present invention, the resist film coated onto a substrate is, for example, a dried film obtained by coating the organic solvent-based or aqueous composition onto the substrate and volatilizing the organic solvent or water as required. Alternatively, a dry film comprising the resin composition of the present invention can be heated and pressed onto a substrate to thereby form the resist film. In this case, the dry film is obtained, for example, by coating the organic solvent-based or aqueous composition onto the surface of a base film such as a PET film and volatilizing the organic solvent or water. The thus-obtained dry film on the base film is heated and pressed onto a substrate. Then, the base film is stripped off.

The resin composition can be coated by means such as rollers, roll coaters, spin coaters, curtain roll coaters, spraying, electrostatic coating, dipping coating, silk printing, and spin coating.

In the present invention, the active energy ray irradiated that can be used is an active energy ray conventionally known in the art. A light source for the active energy ray is not particularly limited. For example, an ultra-high-voltage, high-voltage, medium-voltage, or low-voltage mercury lamp, chemical lamp, carbon arc lamp, xenon lamp, metal halide lamp, or tungsten lamp can be used.

The resin composition of the present invention remarkably shows anti-halation effect in case that the active energy ray comprises a three-ray mixture of an i-ray (365 nm in wavelength), an h-ray (405 nm in wavelength), and a g-ray (436 nm in wavelength).

A method for forming a resist pattern of the present invention comprises the steps of:
(1) applying the active energy ray-curable resin composition of the present invention onto a substrate to thereby form a resist film with a predetermined thickness;
(2) irradiating the resist film directly or via a negative mask with an active energy ray to thereby cure the resist film into a desired pattern; and
(3) developing the resist film cured in the desired pattern (e.g., an image pattern) to thereby form a resist pattern onto the substrate.

The irradiation dose of the active energy ray is usually 100 to 10000 J/m², preferably 500 to 7000 J/m².

The substrate is, for example, a substrate used in the production of semiconductor devices or liquid crystal display devices. The surface of the substrate on which the resist film is formed is a surface comprising, for example, a silicon oxide film, a silicon nitride film, polysilicon, molybdenum, tantalum, tantalum oxide, chromium, chromium oxide, aluminum, or ITO.

The resist film thickness is preferably 0.5 to 20 μm, more preferably 1 to 10 μm, particularly preferably 1 to 5 μm.

Both alkaline and acidic liquid developers can be used as the liquid developer used in the developing treatment. Examples of the alkaline liquid developer include triethylamine, diethanolamine, triethanolamine, ammonia, sodium metasilicate, potassium metasilicate, sodium carbonate, and tetraethylammonium hydroxide aqueous solutions. Examples of the acidic liquid developer include acetic acid, formic acid, and hydroxyacetic acid. The concentration of the liquid developer is usually 0.5 to 3% by weight, preferably 0.6 to 2% by weight. The temperature of the developing treatment is usually 20 to 50° C., and the time thereof is usually 20 to 120 seconds.

After the completion of the development, etching treatment is usually performed. The etching includes dry etching and wet etching, and both of the methods are applicable. Wet etching is generally used for the production of liquid crystal display devices, particularly ITO substrates. A predetermined pattern can be formed on the substrate after etching treatment in this manner.

Then, the resist film is usually stripped off. For example, an alkaline aqueous solution or organic solvent solution may be used to wash off the resist film Examples of the alkaline aqueous solution include sodium hydroxide, potassium hydroxide, ammonia, triethanolamine, and triethylamine aqueous solutions. Examples of the organic solvent include 1,1,1-trichloroethane, methylethylketone, and methylene chloride. When the organic solvent is used, the resist film can also be stripped off by dissolving the resist film therein. The stripping treatment can be practiced by dipping the substrate in the solution, usually at a temperature of 20 to 80° C., usually for 1 to 30 minutes.

### EXAMPLES

Hereinafter, the present invention will be described more specifically with reference to Examples and Comparative Example. However, the scope of the present invention is not intended to be limited to them. In the descriptions below, a “part” denotes a “part by weight”.

### Synthesis Example 1 (Synthesis of Resin 1)

An acrylic resin (resin acid value of 600 mg KOH/g, styrene/acrylic acid=20/80 at weight ratio) was reacted with 125 parts of glycidyl methacrylate to obtain Resin 1 (resin solid content of 55% by weight, propylene glycol monomethyl ether organic solvent, resin acid value of 55 mg KOH/g, weight-average molecular weight of approximately 50,000).

### Synthesis Example 2 (Synthesis of Resin 2)

In 370 parts of epichlorohydrin, 199 parts of trisphenolmethane epoxy resin with an epoxy equivalent of 205 (g/eq) were dissolved. Tetramethyl-ammonium chloride was then added thereto, and further, an NaOH aqueous solution was added dropwise and reacted at 70° C. for 3 hours. After the completion of the reaction, the mixture was washed with water, and the epichlorohydrin was distilled off under reduced pressure. The resulting reaction product was further dissolved in methylisobutylketone, and an NaOH aqueous solution was added thereto and reacted at 70° C. for 1 hour. After the completion of the reaction, the mixture was washed with water, and the methylisobutylketone was subsequently distilled off to obtain 195 parts of an epoxy resin (a) with an epoxy equivalent of 189 (g/eq).

In acrylic acid (68.5 parts) and carbitol acetate, 189 parts of the epoxy resin (a) were dissolved. The mixture was then reacted at 95° C. in the presence of methoquinone and triphenylphosphine. After the confirmation of the acid value brought to 1.0 (mg KOH/g) or less, a tetrahydrophthalic anhydride (101.3 parts) and carbitol acetate were added thereto and reacted. At the point in time when the acid value reached 104 (mg KOH/g), the reaction was terminated to obtain an acid-denatured epoxy acrylate resin (Resin 2).

### Synthesis Example 3(Synthesis of Resin 3)

In epichlorohydrin (370 parts) and dimethyl sulfoxide, 240 parts of a cresol novolac epoxy resin with an epoxy equivalent of 199 (g/eq) were dissolved. NaOH was then added thereto and reacted at 70° C. for 3 hours. Unreacted epichlorohydrin and dimethyl sulfoxide were subsequently distilled off under reduced pressure. The resulting reaction product was further dissolved in methylisobutylketone. An NaOH aqueous solution was then added thereto and reacted at 70° C. for 1 hour. After the completion of the reaction, the mixture was washed with water, and the methylisobutylketone was subsequently distilled off to obtain 241 parts of an epoxy resin (b) with an epoxy equivalent of 190 (g/eq).

In acrylic acid (68.5 parts) and carbitol acetate, 190 parts of the epoxy resin (b) were dissolved. The mixture was then reacted at 95° C. in the presence of methoquinone and triphenylphosphine. After the confirmation of the acid value brought to 1.0 (mg KOH/g) or less, a hexahydrophthalic anhydride (121.6 parts) and carbitol acetate were added thereto and reacted. At the point in time when the acid value reached 110 (mg KOH/g), the reaction was terminated to obtain an acid-denatured epoxy acrylate resin (Resin 3).

### Synthesis Example 4 (Synthesis of Resin 4)

In epichlorohydrin (925 parts) and dimethyl sulfoxide, 371 parts of a bisphenol F epoxy resin with an epoxy equivalent of 650 (g/eq) were dissolved. NaOH was then added thereto and reacted at 70° C. for 3 hours. Unreacted epichlorohydrin and dimethyl sulfoxide were subsequently distilled off under reduced pressure. The resulting reaction product was further dissolved in methylisobutylketone. An NaOH aqueous solution was then added thereto and reacted at 70° C. for 1 hour. After the completion of the reaction, the mixture was washed with water, and the methylisobutylketone was subsequently distilled off to obtain 365 parts of an epoxy resin (c) with an epoxy equivalent of 379 (g/eq).

In acrylic acid (68.5 parts) and carbitol acetate, 379 parts of the epoxy resin (c) were dissolved and then reacted in the presence of methoquinone and triphenylphosphine. After the confirmation of the acid value brought to 1.0 (mg KOH/g) or less, a maleic anhydride (99 parts) and carbitol acetate were added thereto and reacted. At the point in time when the acid value reached 100 (mg KOH/g), the reaction was terminated to obtain an acid-denatured epoxy acrylate resin (Resin 4).

### Examples 1 to 8 and Comparative Example 1

Active energy ray-curable resin compositions were obtained by formulation according to formulated composition shown in Table 1 (each amount formulated in Table 1 corresponds to solid content formulation).

<Evaluation>

The active energy ray-curable resin compositions of Examples 1 to 8 and Comparative Example 1 were separately coated onto glass substrates (1 mm in thickness, 200 mm in length, and 200 mm in width) by use of a curtain flow coater and then dried to prepare resist films with their respective film thicknesses shown in Table 1. The obtained resist films were subjected to evaluations described below. The results are also shown in Table 1.

(1) Measurement of Ratio (Y/X) Between Quantities of Active Energy Rays:

The obtained resist films were irradiated with an active energy ray from a UV lamp (35 atm) comprising a three-ray mixture of an i-ray (365 nm in wavelength), an h-ray (405 nm in wavelength), and a g-ray (436 nm in wavelength). The ratio (Y/X) of a quantity of a transmitted active energy ray (Y) after transmission through the resist film to a quantity of an initial active energy ray (X) on the surface of the resist film in a spectral sensitivity wavelength range of the resist film was determined by the method described above according to the formula [Y′/Z].

(2) Developability:

The surfaces of the obtained resist films were exposed via a wiring mask to an active energy ray from a UV lamp (35 atm) comprising a three-ray mixture of an i-ray (365 nm in wavelength), an h-ray (405 nm in wavelength), and a g-ray (436 nm in wavelength) at their respective irradiation doses shown in Table 1. Subsequently, development was carried out at 30° C. for 120 seconds with 1% by weight of sodium carbonate aqueous solution, and the shapes of the formed resist patterns were observed.
“\textcircled{∘}”: A particularly good resist pattern with a sharp boundary part between the irradiated part and the unirradiated part could be formed.
“◯”: A good resist pattern with a sharp boundary part between the irradiated part and the unirradiated part could be formed.

“×”: An unpractical resist pattern without a sharp boundary part between the irradiated part and the unirradiated part was formed.

TABLE I

| | | | | | | | | | | Comp. |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 |
| Resin 1 | | 100 | 100 | 100 | 100 | 100 | | | | 100 |
| Resin 2 | | | | | | | 100 | | | |
| Resin 3 | | | | | | | | 100 | | |
| Resin 4 | | | | | | | | | 100 | |
| IRGACURE 907 | | 5 | 5 | 5 | | | | | | 5 |
| CGI-784 | | | | | 5 | | | | | |
| IRGACURE 369 | | | | | | 5 | 5 | 5 | 5 | |
| ORASOL YELLOW 4GN | | 2.5 | | | | | | | | |
| OIL COLORS YELLOW GGS | | | 2.5 | | | | | | | |
| SOLVENT YELLOW 56 | | | | | | | | | | |
| NEPTUN YELLOW 075 | | | | 2.5 | 2.5 | 2.5 | 2.5 | 2.5 | 2.5 | 0 |
| Resist film thickness (μm) | | 10 | 10 | 10 | 10 | 10 | 10 | 5 | 5 | 10 |
| Irradiation Dose (J/m²) | | 2000 | 2000 | 2000 | 2000 | 1000 | 5000 | 5000 | 3000 | 2000 |
| Quantity of | Y/X | 10% or | 10% or | 5% or | 5% or | 5% or | 5% or | 5% or | 5% or | 80% or |
| energy ray transmitted | | less | less | less | less | less | less | less | less | more |
| | Degree of | low for all | low for all | low for all | low for all | low for all | low for all | low for all | low for all | large for |
| | transmission | g-, h-, and | g-, h-, and | g-, h-, and | g-, h-, and | g-, h-, and | g-, h-, and | g-, h-, and | g-, h-, and | g- and |
| | of ray | i- rays | i- rays | i- rays | i- rays | i- rays | i- rays | i- rays | i- rays | h-rays |
| Developability | | ◯ | ◯ | ⊚ | ⊚ | ⊚ | ⊚ | ⊚ | ⊚ | x |

1. An active energy ray-curable resin composition, wherein when the active energy ray-curable resin composition is coated onto a substrate and made into a resist film with a predetermined thickness, a ratio (Y/X) of a quantity of a transmitted active energy ray (Y) after transmission through the resist film to a quantity of an initial active energy ray (X) on the surface of the resist film is 10% or less in a spectral sensitivity wavelength range of the resist film.

2. The active energy ray-curable resin composition according to claim 1, wherein the active energy ray-curable resin composition comprises
(A) a base resin comprising an unsaturated group and an ionic group,
(B) a radical photoinitiator, and
(C) a light absorbent.

3. The active energy ray-curable resin composition according to claim 1, wherein the wavelength of the active energy ray comprises a three-ray mixture of an i-ray (365 nm in wavelength), an h-ray (405 nm in wavelength), and a g-ray (436 nm in wavelength).

4. The active energy ray-curable resin composition according to claim 2, wherein the light absorbent (C) absorbs a wavelength of 400 nm or more.

5. The active energy ray-curable resin composition according to claim 2, wherein the light absorbent (C) is a monoazo compound.

6. The active energy ray-curable resin composition according to claim 2, wherein the light absorbent (C) is a yellow light absorbent.

7. The active energy ray-curable resin composition according to claim 2, wherein the light absorbent (C) is a compound represented by the following general formula (I): 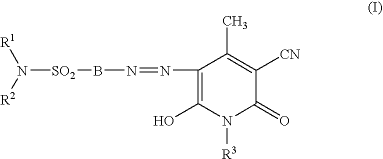
wherein R¹ represents a hydrogen atom, alkyl group, aryl group, cycloalkyl group, or aralkyl group, R² represents an alkyl group having 5 or more carbon atoms, R³ represents a hydrogen atom or alkyl group having 1 to 6 carbon atoms, and B represents a benzene ring which may have a nitro group, cyano group, alkyl group, alkoxy group, chlorine, bromine, phenyl group, or phenoxy group.

8. A method for forming a resist pattern, comprising the steps of:
(1) applying the active energy ray-curable resin composition of claim 1 onto a substrate to thereby form a resist film with a predetermined thickness;
(2) irradiating the resist film directly or via a negative mask with an active energy ray to thereby cure the resist film into a desired pattern; and
(3) developing the resist film cured in the desired pattern to thereby form a resist pattern onto the substrate.

9. An active energy ray-curable resin composition, wherein the active energy ray-curable resin composition has a property of an energy ratio of 0.10 or less, wherein the energy ratio is a transmitted energy of an active energy ray through the active energy ray-curable resin composition of 0.5-20 μm thickness divided by an initial energy of the active energy ray before transmission through the active energy ray-curable resin composition.

10. The active energy ray-curable resin composition according to claim 9, wherein the active energy ray-curable resin composition comprising:
a base resin comprising an unsaturated group capable of polymerizing caused by active energy ray irradiation and an ionic group,
a radical photoinitiator, and
a light absorbent that absorbs a wavelength of 400 nm or more.

11. A resist pattern comprising the active energy ray-curable resin composition according to claim 9.

12. A semiconductor substrate having a resist pattern according to claim 11 developed thereon.
